(19) United States
(12) Patent Application Publication
(10) Pub. No.: US 2017/0184090 A1
(43) Pub. Date: Jun. 29, 2017

(54) RECIPROCATING WATER PUMP

(71) Applicant: Super Products LLC, New Berlin, WI (US)

(72) Inventors: Jason David Hetcher, Waukesha, WI (US); Curtis J. Ladish, Brookfield, WI (US); Michael James Jacobson, DePere, WI (US); Devin Purcell Bader, Brookfield, WI (US)

(73) Assignee: Super Products LLC, New Berlin, WI (US)

(21) Appl. No.: 15/458,317

(22) Filed: Mar. 14, 2017

Related U.S. Application Data
(63) Continuation-in-part of application No. 14/152,376, filed on Jan. 10, 2014, now abandoned.
(60) Provisional application No. 61/751,323, filed on Jan. 11, 2013.

(51) Int. Cl. F04B 49/00; B60P 3/22; F04B 53/16; F04B 49/08; F04B 1/02; F04B 53/14

(52) U.S. Cl. CPC F04B 49/002; F04B 1/02; F04B 53/144; F04B 53/162; F04B 49/08; B60P 3/225; F04B 53/143

(57) ABSTRACT

A reciprocating jetting water pump primarily for use on a vacuum truck is disclosed. The jetting water pump includes a pair of reciprocating pistons that are each movable within an outer cylinder mounted to a center block. Each of the outer cylinders is mounted to the center block by a plurality of tie-rod that each extend between the center block and an end plate. An airflow passageway is formed in the center block to vent air trapped within the open interior of the first outer cylinder during reciprocating movement of the piston in the first outer cylinder. A control system mounted to the vacuum truck senses the pressure of water leaving the jetting water pump and controls the supply of pressurized hydraulic fluid to the jetting water pump to maintain the water pressure at an operator selected value.

### CROSS REFERENCE TO RELATED APPLICATIONS

The present application is a continuation-in-part of U.S. patent application Ser. No. 14/152,376, filed on Jan. 10, 2014, which in turn is based on and claims priority to U.S. Provisional Patent Application Ser. No. 61/751,323, filed on Jan. 11, 2013, the disclosures of which are both incorporated herein by reference.

### BACKGROUND OF THE INVENTION

The present disclosure generally relates to a reciprocating water pump. More specifically, the present disclosure relates to a reciprocating jetting water pump for use in a vacuum truck used in the sewer cleaning and hydro-excavation industry and for use in a sewer jetter truck.

Presently, sewer and catch basin cleaners are available that include a large suction device for removing debris from within a sewer line. As part of the sewer and catch basin cleaner, a water pump system is included on the vehicle that creates a pressurized supply of water that is used to loosen and remove debris from the interior walls of a sewer line, which is then sucked into a debris tank on the vehicle. As part of this high pressure water cleaning system, a jetting water pump is used on the machine to create the supply of pressurized water.

Current jetting water pumps used in the sewer cleaning industry and the hydro-evacuation industry suffer from issues with respect to seal wear, serviceability, the setting of water pressure and measuring water flow, the preparation for cold weather storage and the cost of replacement cylinders. The present disclosure addresses many of these issues.

### SUMMARY OF THE INVENTION

The present disclosure generally relates to a reciprocating jetting water pump. More specifically, the present disclosure relates to a reciprocating jetting water pump that improves seal wear, serviceability and includes a control system that allows for water pressure settings by the user.

Current jetting water pumps used in the sewer cleaning industry and the hydro-excavation industry suffer from issues with respect to seal wear, serviceability, setting water pressure and measuring water flow, preparing for cold weather storage, and cost of replacement cylinders.

The jetting water pump of the present disclosure improves the wear life of the water pump seal by using a piston with a sealing strip positioned between separate strips of stainless steel. The polymer sealing strip of the piston provides very high seal efficiency for very long periods of time. The pistons used on each side of the reciprocating jetting water pump of the present disclosure maintain high seal efficiency even without an elastomeric seal, and even when the cylinder inside diameter wears or pits. Cylinder pitting is particularly damaging to an elastomeric seal.

The present disclosure improves the ability of the operator to change the pump seals by utilizing a series of tie-rods to connect each of the first and second outer cylinders onto the center block. A seal is created between the cylinder and the end block with a simple O-ring seal. The tie-rods can be removed to service one side of the pump while the other side of the pump remains assembled.

The jetting water pump of the present disclosure includes an airflow passageway that extends between an open interior of the center block and a location near the vertically highest point of an open interior of the first outer cylinder. As water flows past an opening to the airflow passageway, the flow of water creates Venturi suction that draws air out of the open interior of the first outer cylinder. Since air rises in the open interior of the first outer cylinder, the airflow passageway opens into the vertically highest point of the open interior to be in communication with any air trapped in the open interior. The end plate connected to the opposite side of the first outer cylinder includes another airflow passageway that vents air from within the open interior as the piston reaches the end of travel near the end plate. Drain ports on the bottom of the first outer cylinder to allow all the water to be drained out prior to storage.

The center block further includes a water passageway that extends between the open interior of the first outer cylinder and the open interior of the center block. The water passageway allows water to be drained from the open interior of the first outer cylinder to winterize the pump.

The outer cylinders of both the water side and hydraulic side of the jetting water pump are formed from carburized heat treated material instead of high alloy through hardened material. High alloy material is expensive and is available from very few sources. The outer cylinders are formed from common hydraulic cylinder grade material to increase availability and reduce cost. Carburizing and plating the inside diameter will provide the same benefit as through hardening at reduced cost.

The water cylinder is subject to wear from the high pressure water being pumped. This wear is aggravated by the presence of fine debris or contaminants in the water such as rust flakes from the water supply pipes. The water cylinders are also subject to corrosion from the water itself especially chlorinated city water. The water cylinders of the present disclosure include an alloy coating on the inside diameter of the water cylinder that includes tungsten carbide. An alloy coating with tungsten carbide offers superior wear and corrosion protection compared to hard chromium coating. The new coating will benefit machine owners by extending the life of the water pump and reduce the down time of repairs.

The control system of the present disclosure is able to monitor seal conditions by comparing hydraulic flow to water flow. The control system will read both hydraulic flow and water flow to verify pump performance and to calculate pump efficiency. Pump efficiency can then be used to inform the operator of service needs such as when it is time to change the seal.

### BRIEF DESCRIPTION OF THE DRAWINGS

The drawings illustrate the best mode presently contemplated of carrying out the disclosure. In the drawings:

FIG. 1 is a depiction of a sewer and catch basin cleaner that incorporates the system of the present disclosure;

FIG. 2 is a schematic illustration of the operating system of the present disclosure;

FIG. 3 is a perspective view of the reciprocating water pump of the present disclosure;

FIG. 4 is a section view taken along line 4-4 of FIG. 3;

FIG. 5 is a magnified section view taken along line 5-5 of FIG. 4;

FIG. 6 is a magnified view of the outer surface of one of the moving pistons within the reciprocating water pump;

FIG. 7 is a magnified section view taken along line 7-7 of FIG. 4; and

FIG. 8 is a section view similar to FIG. 7.

### DETAILED DESCRIPTION OF THE DRAWINGS

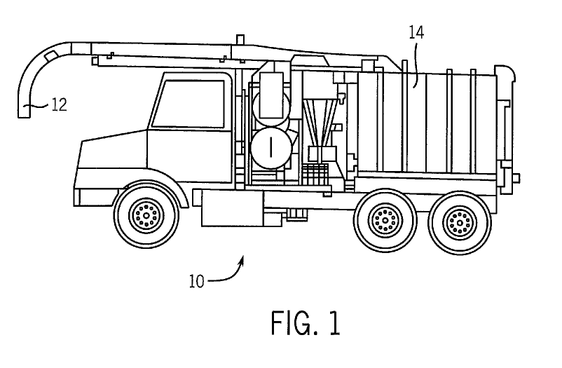

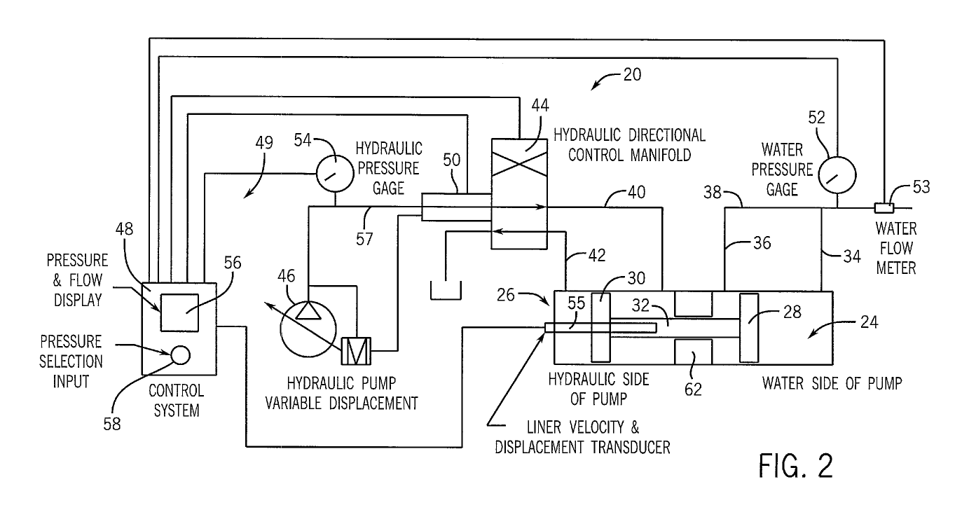

A vacuum truck, such as a sewer and catch basin cleaning truck 10, is shown in FIG. 1. Although a sewer and catch basin cleaning truck 10 is shown in FIG. 1, the system of the present disclosure could be used with other types of vacuum trucks, such as hydro excavators, liquid vacuum trucks, industrial vacuum loaders or sewer jetter trucks. The sewer cleaning truck 10 shown in FIG. 1 includes an extendable suction hose 12 that removes debris from within a sewer and stores the removed debris within an onboard debris tank 14. The cleaning truck further includes a hydro-evacuation system that directs a high pressure flow of water into the sewer to loosen debris within the sewer and direct the loosened debris toward the suction hose 12. An example of such a cleaning truck is the Camel® sold by Super Products of New Berlin, Wisconsin. Referring now to FIG. 2, the water pump system 20 of the present disclosure is shown schematically. The system includes a dual acting reciprocating jetting water pump 22. The jetting water pump 22 includes a water side 24 and a hydraulic side 26 separated and connected to a center block 62. The water side 24 includes a reciprocating piston 28 while the hydraulic side 26 includes a similar reciprocating piston 30. The reciprocating pistons 28, 30 are each connected to each other by a rod 32 that passes through the center block 62.

The water side 24 of the pump 22 includes a pair of outlet lines 34, 36 that are located on opposite sides of the reciprocating piston 28. The pair of outlet lines 34, 36 come together to create a water outlet line 38 that is pressurized and is used by an operator to loosen and remove debris from within the sewer line. The reciprocating action of the piston 28 within the water side 24 creates a continuous flow of water in the water outlet line 38. The reciprocating movement of the piston 28 is controlled and driven by the piston 30 in the hydraulic side 26.

The vacuum truck includes a control system 49 that controls the operation of the jetting water pump 22 through a pair of hydraulic fluid lines 40, 42 that selectively directs pressurize hydraulic fluid to opposite sides of the piston 30. A hydraulic direction control manifold 44 controls the supply of hydraulic fluid to opposite sides of the piston 30 on the hydraulic side 26 of the jetting water pump 22 from a hydraulic pump 46. The control system includes a control unit 48 that operates to control a pressure control valve 50 through associated control lines. The setting of the flow pressure control valve 50 controls the operation of the jetting water pump 22 and thus the water pressure leaving the jetting water pump 22.

The control unit 48 may be microprocessor-based and receives signals from various sensors and delivers control signals to devices mounted to the vacuum truck. The control unit can a microprocessor or could be a PLC controller.

In accordance with the present disclosure, both a water pressure gauge 52 and a water flow meter 53 are positioned in the water outlet line 38. Both the water pressure gauge 52 and the water flow meter 53 are in communication with the control unit 48 such that the control unit 48 can monitor the pressure of water leaving the jetting water pump 22 as well as the flow rate of the water from the jetting water pump 22. The water pressure gauge 52 and the water flow meter 53 provide separate signals to the control unit 48 such that the control unit 48 can separately monitor both the flow rate and the pressure of the water in the water outlet line 38.

A hydraulic pressure gauge 54 is positioned in the hydraulic fluid line 57 extending between the hydraulic pump 46 and the control manifold 44. The hydraulic pressure gauge 54 determines the pressure of the hydraulic fluid and provides information to the control unit 48 concerning the pressure of hydraulic fluid reaching the hydraulic side 26 of the pump 22.

The jetting water pump 22 includes a linear velocity and displacement transducer 55 that monitors the movement of the piston 30 in the jetting water pump 22. The transducer 55 is a stationary device that senses the movement of the piston 30 within the jetting water pump 22. The transducer 55 is in communication with the control unit 48 such that the control unit 48 can monitor the movement of the pistons 28 and 30.

In accordance with the control system of the present disclosure, a user is able to enter a desired outlet pressure for water from the jetting water pump 22 through an input device 58. The control unit 48 of the control system is operable to control the water pressure in the water outlet line 38. The pressure selection input received at the control unit 48 is the only adjustment necessary from the operator for controlling water pressure through the entire range of operation from 0 psi (OFF) to the maximum pressure rating of the system. This is an improvement over prior art systems that require and On/Off switch, a pressure range selection switch, and a pressure switch. The control unit 48 can display the water pressure and other relevant values on the display 56.

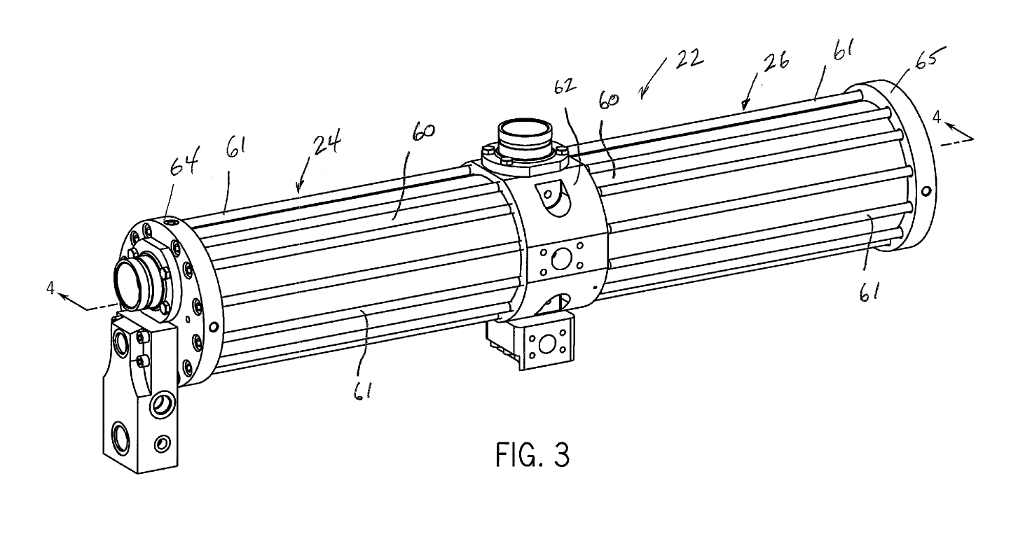

FIG. 3 illustrates the jetting water pump 22 of the present disclosure. The jetting water pump 22 includes both the hydraulic side 26 and the water side 24 as was described in the schematic illustration of FIG. 2. Both the water side 24 and the hydraulic side 26 include an outer cylinder 60 that surrounds the moving pistons contained within each side of the jetting water pump. The outer cylinders 60 are each joined to the center block 62 through a series of tie-rods 61 that each include threaded ends that are received in the center block 62 and one of the end plates 64 and 65. Each of the cylinders receives one of the end plates 64 or 65 to define the open interior of the respective side of the jetting water pump 22.

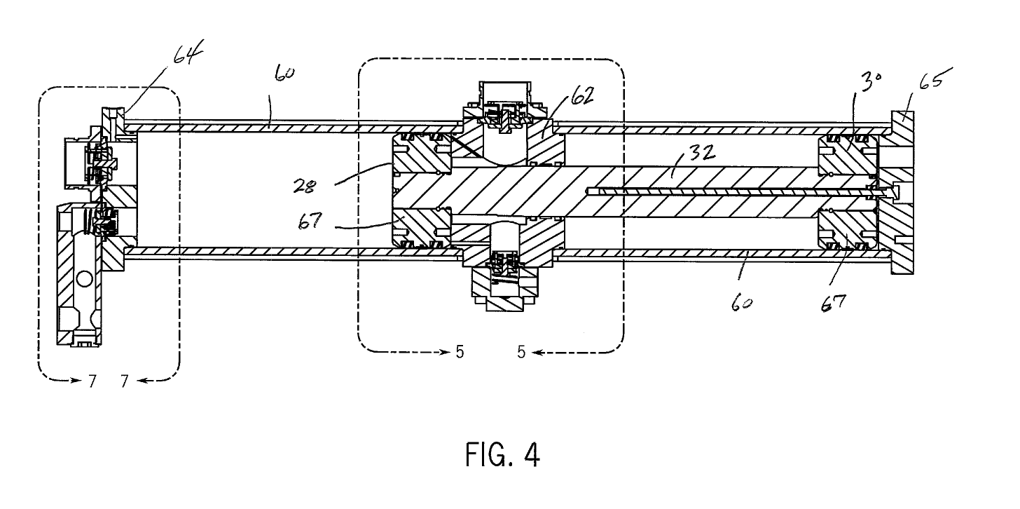

As illustrated in FIG. 4, each of the pistons 28, 30 are connected to the connecting rod 32. The connecting rod 32 passes through the center block 62. A series of resilient seals formed on the hydraulic side of the center block 62 provide for fluid separation between the hydraulic fluid and the water being pumped as the connecting rod move through the center block 62. The main body 67 of each of the pistons 28, 30 is connected to one end of the connecting rod 32. In the embodiment illustrated, the main body 63 of each of the pistons 28, 30 is formed from a metallic material, such as but not limited to aluminum.

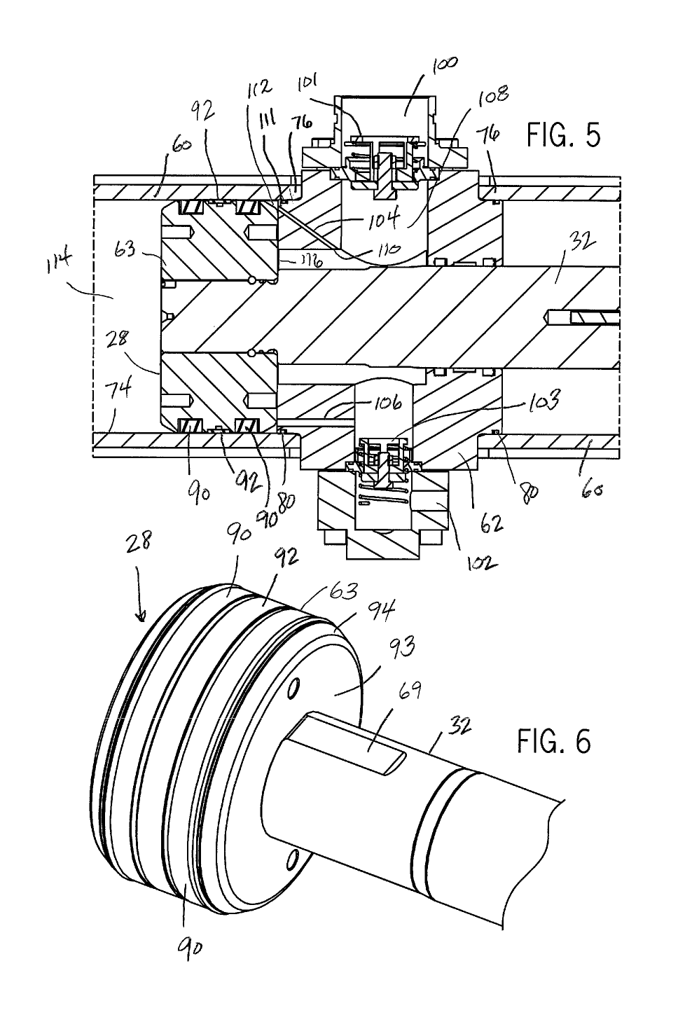

As shown in FIG. 6, the main body 63 of the piston 28 is securely attached to one end of the connecting rod 32. The connecting rod 32 includes a flat surface 69 that allows a pipe wrench to aid in attaching the main body 63 to the piston rod 32. As can be seen in FIGS. 5 and 6, the outer surface of the main body 63 receives a pair of stainless steel inserts 90 that extends around the outer surface of the main body 63. A resilient sealing strip 92 is positioned between the stainless steel inserts 90 to provide a fluid seal between the outer surface of the piston the inner surface 74 of the cylinder, as best shown in FIG. 5. The stainless steel inserts 90 contact the inner surface 74 and increase the durability of the main body 63. The main body 63 further includes a machined radius edge 94 that transitions to the outer surface of the piston body from the inner face surface 93.

As can be understood in FIG. 4, the piston 28, as well as the corresponding opposite piston 30, is designed with a very small radial clearance over its axial length between its outer surface defined by the stainless steel inserts 90 and the resilient sealing strip 92 and the inner surface 74 of the cylinder 60. Specifically, the resilient sealing strip 92 is are spaced very closely to the inner surface 74 of the cylinder 60, which provides a very high seal efficiency for extended periods of use. In addition, the relatively narrow sealing strip 92 further increases the sealing efficiency for the piston 28.

In the preferred embodiment of the disclosure, each of the cylinders 60 is formed from a carburized heat-treated material instead of a high alloy as used in many other reciprocating water pumps. The high alloy material used in prior art reciprocating water pumps is both expensive and not readily available. Utilizing cylinders 60 that are formed from common hydraulic cylinder grade material increases the availability and reduces the cost of the cylinders. In accordance with the present disclosure, the inner surface 74 of each cylinder 60 is heat treated and plated to provide the same benefit as a high alloy.

Referring back to FIG. 5, each of the cylinders 60 includes a connecting end 76 that is received along a portion of the center block 62. A resilient O-ring 80 is positioned between the center block 62 and the connecting end 76 of the cylinder 60 to provide a sealing arrangement as illustrated. As described in FIG. 3, the series of tie-rods 61 are threadedly received at opposite ends in both the center block 62 and one of the end plates 64, 65 to hold the individual cylinders 60 in the assembled condition. The multiple tie-rods 61 clamp the cylinders 60 between one of the end plates and the center block independently from each other. Thus, each of the cylinders 60 can be independently removed from the center block 62 and the respective end plate 64, 65. In this manner, one of the cylinders 60 can be removed while the other side of the pump remains completely intact. This allows for servicing of one side of the jetting water pump 22 without having to dissemble the opposite the side of the jetting water pump.

Referring now to FIG. 5, the center block 62 includes a water inlet port 100 and a one way flow control valve 101 and a water outlet port 102 with a one way flow control valve 103. The center block 62 includes an airflow passageway 104 and a water passageway 106. When the piston 28 is moving away from the center block 62, the seal created between the outer surface of the piston 28 by the resilient sealing strip 92 and the inner surface 74 of the cylinder 60 draws a flow of water into the inlet 100. As the water is being drawn into the open interior 108, the water flows over the opening 110 of the airflow passageway 104. The flow of water over the opening 110 creates a Venturi suction which draws any air contained within the void 112 between the piston 28 and the inner surface 74 of the cylinder into the open interior of the center block 62. The airflow passageway 104 includes an upper opening 111 that opens into the open interior 114 near the vertically highest point of the open interior 114. Since air rises within the water being pumped, the vertically highest point of the open interior 114 includes the trapped air. In this manner, air is allowed to escape the open interior 114 of the cylinder 60 through the airflow passageway 104. Air entrapped within the open interior 114 of the cylinder is bad for efficiency and creates pulsations when the pump shifts directions.

Once the piston 28 reaches its end of travel, the piston 28 changes direction and begins to move back toward the center block 62. During this return movement, water is forced from the open interior 114 and out through the outlet port 102. During this movement, water flows through the water passageway 106. In addition, water flows quickly past the opening 110 of the airflow passageway 104. As described previously, air can be entrapped at the void 112 between the back surface 116 of the piston and the center block 62 and the flow of water over the opening 110 draws the air out of the open interior 114 of the cylinder 60.

The water passageway 106 serves as a drain port that allows all of the water to be evacuated from the vertically lowest portion of the cylinder during winterization of the pump. In such case, the supply of water to the inlet 100 is removed and the reciprocating movement of the piston 28 forces any water remaining in the open interior 114 out through the water passageway 106 since the water passageway is located at the vertically lower side of the cylinder 60.

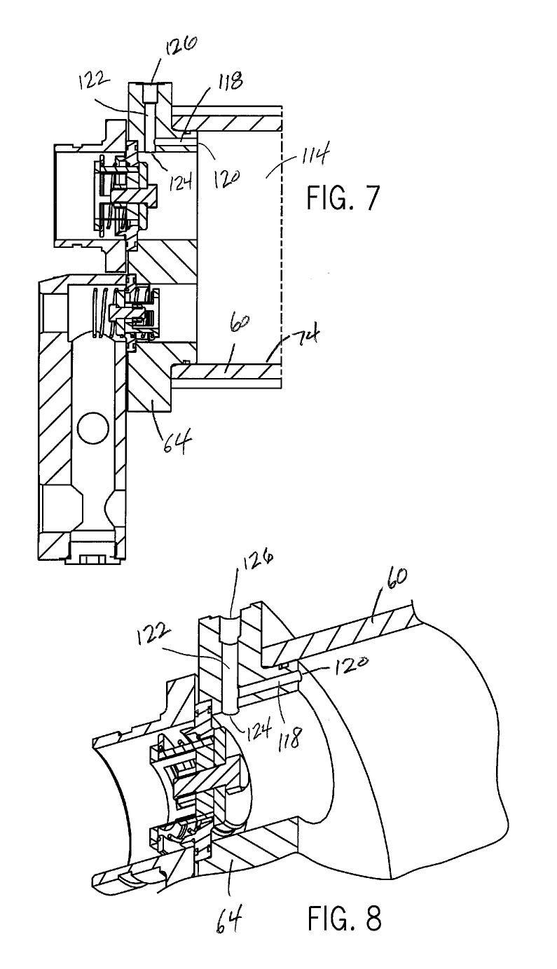

Referring now to FIGS. 7 and 8, a second airflow passageway 118 is formed within the end plate 64. The second airflow passageway 118 has an opening 120 that is in communication with the open interior 114 of the cylinder 60. The opening 120 is located near the vertically highest point of the open interior 114 due to the air rising within the water being pumped from the open interior 114. As the piston 28 moves toward the end plate 64, any air entrapped between the piston and the end plate 64 leaves the open interior through the airflow passageway 118. The airflow passageway 118 is in communication with a vertical passageway 122 that has a corresponding opening 124. In this manner, air entrapped within the cylinder can be vented to atmosphere through the vent opening 126.

Referring back to FIG. 4, each of the end plates 64, 65 is welded onto one of the outer cylinders 60 utilizing a welding technique to prevent fatigue cracking at the root of the weld when the inside of the outer cylinder 60 is repeatedly pressurized during operation. The pressure inside of the outer cylinder 60 on both the water side and the hydraulic side of the jetting water pump will put the root of the weld in tension and, given enough stress cycles, will cause a fatigue crack to develop.

In accordance with the present disclosure, an interference fit is created between the end plates 65 and cylinder tube that defines the outer cylinder 60. The interference fit preloads the outer cylinder in a similar manner as internal pressure will load the outer cylinder during operation. This preload greatly reduces the stress amplitude experienced at the weld root.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims

We claim:

1. A reciprocating water pump, comprising:
a center block having a water inlet, a water outlet and an open interior located between the water inlet and the water outlet;
a first outer cylinder connected to the center block and having an open interior defined by inner surface having a constant inner diameter;
an airflow passageway extending from the open interior of the center block to the open interior of the first outer cylinder;
a second outer cylinder connected to the center block and having an inner surface having a constant inner diameter;
a first piston movably positioned within the first outer cylinder, wherein reciprocating movement of the first piston within the first outer cylinder draws water though the water inlet and out the water inlet;
a second piston movably positioned within the second outer cylinder; and
a connecting rod extending through the center block and connected to both the first piston and the second piston,
wherein the flow of water past the airflow passageway draws air from near a vertically highest point of the open interior of the first outer cylinder into the open interior of the center block.

2. The reciprocating water pump of claim 1 wherein the first outer cylinder and the second outer cylinder each receive an end plate on an outer end and are joined to the center block at an inner end, wherein the first outer cylinder and the second outer cylinder are connected to the center block and one of the end plates by a plurality of tie-rods.

3. The reciprocating water pump of claim 1 further comprising a water passageway formed in the center block and extending between the open interior of the first outer cylinder and the open interior of the center block.

4. The reciprocating water pump of claim 3 wherein the water passageway is formed near a vertically lowest point of the first outer cylinder.

5. The reciprocating water pump of claim 2 wherein the end plate attached to the first outer cylinder includes an airflow passageway having an outlet and an opening in fluid communication with the vertically highest point of the open interior of the first outer cylinder.

6. A truck operable to dispense water, comprising:
a jetting water pump operable to create a supply of water from the truck; and
a control system coupled to the jetting water pump to determine the water pressure from the jetting water pump and control the supply of hydraulic fluid to the jetting water pump to control the water pressure from the jetting water pump,
wherein the jetting water pump comprises:
a center block having a water inlet, a water outlet and an open interior located between the water inlet and the water outlet;
a first outer cylinder connected to the center block and having an open interior defined by inner surface having a constant inner diameter;
an airflow passageway extending from the open interior of the center block to the open interior of the first outer cylinder;
a second outer cylinder connected to the center block and having an inner surface having a constant inner diameter;
a first piston movably positioned within the first outer cylinder, wherein reciprocating movement of the first piston within the first outer cylinder draws water though the water inlet and out the water inlet;
a second piston movably positioned within the second outer cylinder; and
a connecting rod extending through the center block and connected to both the first piston and the second piston,
wherein the flow of water past the airflow passageway draws air from near a vertically highest point of the open interior of the first outer cylinder into the open interior of the center block.

7. The truck of claim 6 wherein the control system further comprises:
a control unit;
a user input device coupled to the control unit to allow an operator to adjust the operational settings of the jetting water pump within the control unit;
a water pressure sensor positioned to determine the water pressure of the output flow of water, wherein the water pressure sensor is in communication with the control unit; and
a hydraulic pressure control valve in communication with the control unit and operable to selectively control the pressure of hydraulic fluid to the jetting water pump.

8. The truck of claim 6 wherein the outer surface of the first piston and the second piston include a resilient sealing strip.

9. The truck of claim 6 wherein the first outer cylinder and the second outer cylinder each receive an end plate on an outer end and are joined to the center block at an inner end, wherein the first outer cylinder and the second outer cylinder are connected to the center block and one of the end plates by a plurality of tie-rods.

10. The truck of claim 6 further comprising a water passageway formed in the center block and extending between the open interior of the first outer cylinder and the open interior of the center block.

11. The truck of claim 10 wherein the water passageway is formed near a vertically lowest point of the first outer cylinder.

12. The truck of claim 9 wherein the end plate attached to the first outer cylinder includes an airflow passageway having an opening in fluid communication with the vertically highest point of the open interior of the first outer cylinder and an outlet.
